(19) United States
(12) Patent Application Publication
(10) Pub. No.: US 2026/0105850 A1
(43) Pub. Date: Apr. 16, 2026

(54) DYNAMICALLY SECURING ELECTRONIC FLIGHT BAG UPLOADS

(71) Applicant: Honeywell International Inc., Charlotte, NC (US)

(72) Inventors: Ravikumar Selvarajan, Madurai (IN); Sreenivasan K Govindillam, Bengaluru (IN)

(21) Appl. No.: 19/036,960

(22) Filed: Jan. 24, 2025

(30) Foreign Application Priority Data
Oct. 10, 2024 (IN) 202411076920

(51) Int. Cl. G08G 5/34; H04L 9/08

(52) U.S. Cl. CPC G08G 5/34; H04L 9/0861

(57) ABSTRACT

An avionics system mounted on an aircraft configured to receive a key request from a computing device, wherein the key request includes key generation parameters; generate an encryption key based on the key generation parameters; transmit the encryption key to the computing device; receive, from the computing device, an encrypted version of an avionics command; decrypt the encrypted version of the avionics command, using a decryption key corresponding to the encryption key, to determine a decrypted version of the avionics command, wherein the decrypted version of the avionics command includes flight information; and in response to determining that the flight information includes the key generation parameters, executing the avionics command.

This application claims the benefit of Indian Provisional Patent Application No. 202411076920, filed Oct. 10, 2024, the entire contents of which are incorporated herein by reference.

### TECHNICAL FIELD

This disclosure relates to systems for facilitating communication between an avionics system and an external computing device.

### BACKGROUND

The avionics industry has been making technological advancements in enabling electronic flight bag (EFB) systems to obtain complex avionics data (e.g., flight plans) from avionics data systems, such as Flight Management Systems (FMSs). The EFB systems can filter and convert complex avionics data into various streaming formats (e.g., JavaScript Object Notation (JSON) or Extensible Markup Language (XML)) and transmit the converted avionics data to various client applications in the EFB systems so that applications of the EFB may utilize the data. Applications being executed by an EFB may similarly transmit data to the FMS, providing pilots with a more user-friendly manner of interacting with the FMS.

### SUMMARY

This disclosure describes techniques that secure the connectivity between an electronic flight bag (EFB) and avionics by limiting an EFB's ability to directly connect or control the avionics, as might be the case if the EFB were connected to the avionics via a user datagram protocol (UDP)/socket-based connection. As will be described in more detail below, a gateway device may be configured to control data communications between an EFB and avionics of an aircraft. The techniques of this disclosure enable avionics, like a flight management system (FMS), to serve requests from EFB applications, using a gateway device as a middleman, thus preventing the EFB from establishing direct internet protocol (IP) connections with the avionics. The communication channel and protocol are controlled by the avionics to facilitate secure transactions.

This disclosure describes techniques to secure the connectivity channels by ensuring that data being uploaded from an EFB to avionics is sufficiently encrypted such that man-in-the-middle attacks or other sorts of attacks cannot be achieved by cyber criminals. As will be described in greater detail below, the encryption mechanism may be governed by various dynamic factors such as the flight phase, the intent behind the upload mission, or other such flight information, such that the encryption, e.g., the encryption key used, is dynamic.

According to an example, computer-implemented method for controlling data communication by avionics of an aircraft includes receiving a key request from a computing device, wherein the key request includes key generation parameters; generating an encryption key based on the key generation parameters; transmitting the encryption key to the computing device; receiving, from the computing device, an encrypted version of an avionics command; decrypting the encrypted version of the avionics command, using a decryption key corresponding to the encryption key, to determine a decrypted version of the avionics command, wherein the decrypted version of the avionics command includes flight information; and in response to determining that the flight information includes the key generation parameters, executing the avionics command.

According to another example, an avionics system mounted on an aircraft includes one or more memories and processing circuitry coupled to the one or more memories and configured to receive a key request from a computing device, wherein the key request includes key generation parameters; generate an encryption key based on the key generation parameters; transmit the encryption key to the computing device; receive, from the computing device, an encrypted version of an avionics command; decrypt the encrypted version of the avionics command, using a decryption key corresponding to the encryption key, to determine a decrypted version of the avionics command, wherein the decrypted version of the avionics command includes flight information; and in response to determining that the flight information includes the key generation parameters, executing the avionics command.

According to another example, a computer-implemented method for controlling data communication with an avionics system of an aircraft includes receiving, at a gateway device, an avionics command from an external computing device, wherein the avionics command includes flight information; extracting from the flight information, by the gateway device, key generation parameters from the avionics command; transmitting, by the gateway device, a key request to the avionics system, wherein the key request includes the key generation parameters; receiving, at the gateway device, an encryption key generated based on the key generation parameters from the avionics system; and transmitting, by the gateway device, an encrypted version of the avionics command to the avionics system.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2A shows a system for implementing secured connectivity between an electronic flight bag (EFB) and avionics in accordance with the techniques of this disclosure.

FIG. 2B is a flow diagram illustrating an example data exchange between an EFB and avionics when performing the techniques of this disclosure.

FIG. 3 is a flow diagram illustrating a data transfer process in accordance with the techniques of this disclosure.

FIG. 4 shows an example of a gateway device for facilitating communication between an avionics system and a computing device for executing EFB applications in accordance with techniques of this disclosure.

FIG. 5 shows an example of a computing device for executing EFB applications in accordance with techniques of this disclosure.

FIG. 6 shows an example of an avionics system in accordance with techniques of this disclosure.

Throughout the figures, like reference numerals across multiple figures refer to the same hardware, software, data, step, etc.

### DETAILED DESCRIPTION

The avionics of modern aircraft often include a flight management system (FMS) that can generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, the FMS may ensure that the aircraft is adhering to the flight plan. In this regard, an FMS may be viewed as the custodian of the flight plan.

An electronic flight bag (EFB) is a computing device used by pilots to review operating manuals, airport diagrams, navigational charts, and other types of reference materials that were previously paper-based. More advanced applications for interacting with an FMS and other aspects of an aircraft's avionics are being added to EFBs. With the advent of data connectivity between FMSs and EFBs, flight plans may be sent back and forth between FMSs and EFBs. For example, an FMS may generate a flight plan and supply the flight plan to an EFB for a variety of purposes such as data analytics, visualization, flight plan optimization, or the like. In other examples, an EFB may generate the flight plan and transmit the flight plan to an FMS for the FMS to execute the uploaded flight plan. This EFB-FMS connectivity brings value to the airlines and pilots in terms of situational awareness, flight efficiency, fuel efficiency, predictive maintenance, among other benefits, which can increase revenue and improve safety.

This EFB-FMS connectivity also potentially presents an entry point for incorrect or corrupted data caused by a malfunction. The EFB-FMS connectivity may also present a security vulnerability that could be exploited by a nefarious actor. For example, cyber criminals could potentially utilize the connectivity channels between EFB applications and avionics to attack, or even take control of, the avionics. For instance, a cybercriminal could take control of an existing EFB application and then, posing as a legitimate EFB application, send malicious commands to the avionics using communication paths allocated for the legitimate EFB applications.

This disclosure describes techniques that secure the connectivity between an EFB and avionics by limiting an EFB's ability to directly connect or control the avionics, as might be the case if the EFB were connected to the avionics via a user datagram protocol (UDP)/socket-based connection. As will be described in more detail below, a gateway device may be configured to control data communications between an EFB and avionics of an aircraft. The techniques of this disclosure enable avionics, like an FMS, to serve requests from EFB applications, using a gateway device as a middleman, thus preventing the EFB from establishing direct internet protocol (IP) connections with the avionics. The communication channel and protocol are controlled by the avionics to facilitate secure transactions.

This disclosure describes techniques to secure the connectivity channels by ensuring that data being uploaded from an EFB to avionics is sufficiently encrypted such that man-in-the-middle attacks or other sorts of attacks cannot be achieved by cyber criminals. As will be described in greater detail below, the encryption mechanism may be governed by various dynamic factors such as the flight phase, the intent behind the upload mission, or other such flight information, such that the encryption, e.g., the encryption key used, is dynamic. This disclosure also describes techniques for verifying encrypted commands. Thus, the techniques of this disclosure may be used to detect corrupt or otherwise invalid commands even if those commands are encrypted using the proper encryption key. Securing data transmission between an EFB and avionics using a gateway device and encryption as described in this disclosure may improve the security of EFB-FMS connectivity.

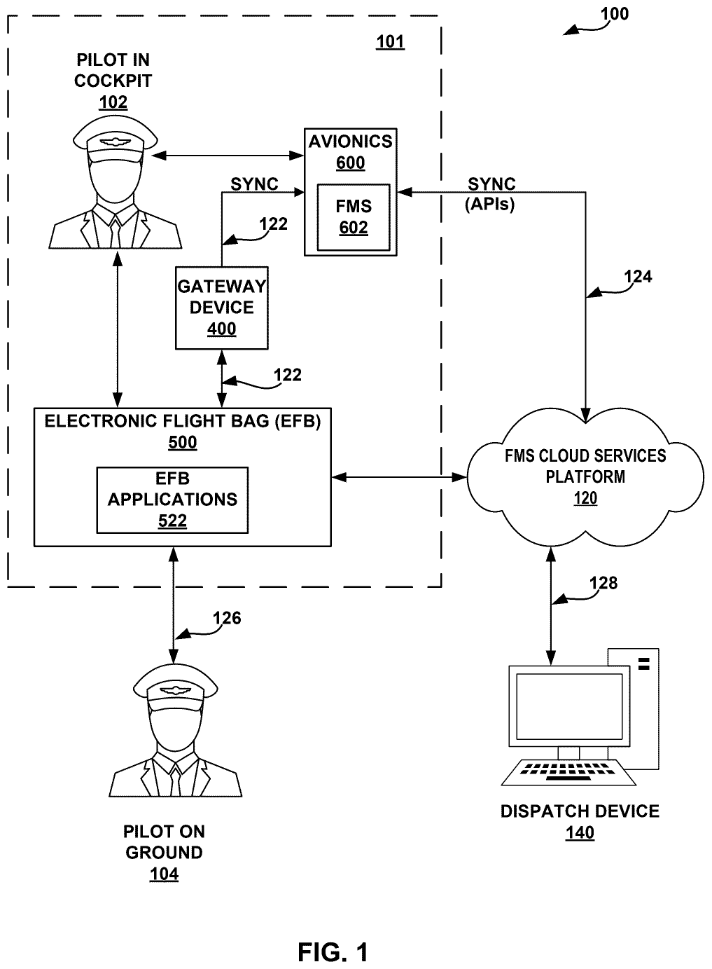

FIG. 1 shows an overview of an example computing environment 100, according to one or more examples of the present disclosure. In environment 100, gateway device 400 is configured to facilitate communication between EFB 500 and avionics 600. Gateway device 400, EFB 500, and avionics 600 are all devices or systems that may be located inside aircraft 101. Environment 100 also includes a connected FMS cloud services platform 120 (platform 120) and a dispatcher device 140, which may be located outside of aircraft 101. EFB 500 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 500 may include a pilot information display (PID).

Avionics 600 generally represents any electronic systems that may be implemented in an aircraft. Avionics 600 may, for example, perform functions related to communication, navigation, safety monitoring, and other such functionality. Avionics 600 includes FMS 602, which represents a specialized computer system with specialized software configured to automate in-flight tasks according to a flight plan. In this regard, FMS 602 may be considered to be a full or partial autopilot system. FMS 602 may, for example, perform real-time monitoring of the aircraft's position using onboard sensors (like GPS) and compare the position to the planned route defined in a the flight plan. FMS 602 may also perform automatic corrections if the aircraft deviates from the planned path by adjusting the course of the aircraft to bring the aircraft back to the path defined in the flight plan.

Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in cockpit, may have access to EFB 500 and EFB applications 522 installed on EFB 500. Pilot 102 may also have access to avionics 600 and FMS 602, through which pilot 102 may access the connected FMS cloud services platform 120. EFB applications 522 may access connected FMS cloud services platform 120 and provide the FMS services to the users of EFB 500 in which the EFB applications 522 are installed. In that way, EFB 500 may provide to pilot 102 user-friendly and customized user interfaces, by which pilot 102 may interact with FMS services from the platform 120.

FMS 602 may also be configured to synchronize data 124 with connected FMS cloud services platform 120, using, for example, an application programming interface (API). In addition, FMS 602 may also be configured to synchronize data 122 with EFB applications 522 via gateway device 400. Thus, in some implementations, FMS 602 may be synchronized with data from both EFB 500 and platform 120 in real-time or at predetermined intervals, in such a way that the pilot 102 may rely on the on-board FMS 602 for all tasks arising in the environment 100. The data being synchronized may, for example, be flight data, although the techniques of this disclosure are not necessarily limited to flight data.

A pilot 104, who may be on ground, may also access EFB 500 and the EFB applications 522. In some implementations, the pilot 104 and the pilot on cockpit 102 may be the same pilot, yet under different circumstances (e.g., time and location of the access). Additionally, or alternatively, the pilot 104 may be a different pilot, or another authorized member of the flight crew, who accesses EFB 500 on the ground for an official duty related to the connected FMS cloud services platform 120. While pilot 104 is accessing the EFB applications 522 via EFB 500, the EFB applications 522 may access the connected FMS cloud services platform 120 to receive various FMS services. In that way, EFB 500 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in the environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 602, EFB 500, and dispatcher device 140 may include one or more devices capable of receiving, generating, storing, processing, and/or providing information associated with FMS services. For example, FMS 602, EFB 500, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 600, EFB 500, or FMS cloud services platform 120, the systems and devices may be configured to transmit and receive flight plans in the form of a. RTE (route) file, a. FPL file, or other file formats. As will be explained in more detail below, gateway device 400 and avionics 600 may be configured to transmit and receive. RTE and. FPL files using the encryption-based process described in this disclosure.

A .RTE file is a standard file format that may be used by FMS 602 and EFB applications 522 to store and exchange flight planning data. As will be illustrated in more detail below, .RTE files include some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may may use .RTE files to plan and file flight routes and ensure compliance with air traffic control and safety regulations. A .RTE file may be uploaded from EFB 500 to FMS 602 to provide necessary flight details for navigation and management during the flight. The interoperability of .RTE files may facilitate sharing of flight plans between different systems and stakeholders (e.g., airlines, airports, air traffic control). Instead of or in addition to .RTE files, FMS 602 and EFB applications 522 may exchange .FPL (flight plan) files, which include similar information as .RTE files and are used for similar purposes as .RTE files, but have a different formatting.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 500 and dispatcher device 140) may be implemented within a single device, or a single device shown in FIG. 1 (e.g., EFB 500, FMS 602, or dispatcher device 140) may be implemented as multiple, distributed devices. Additionally, or alternatively, a set of devices (e.g., one or more devices) of environment 100 may perform one or more functions described as being performed by another set of devices of environment 100.

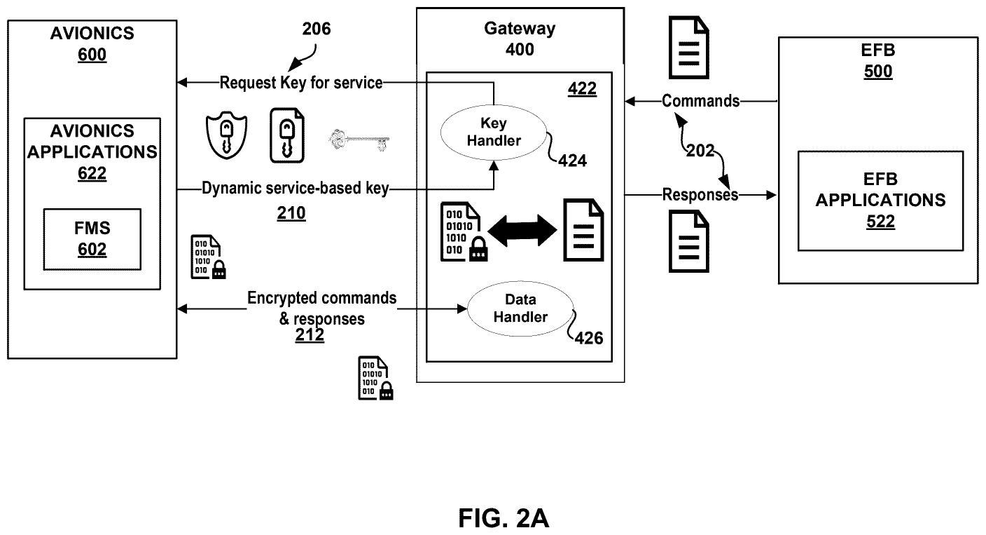

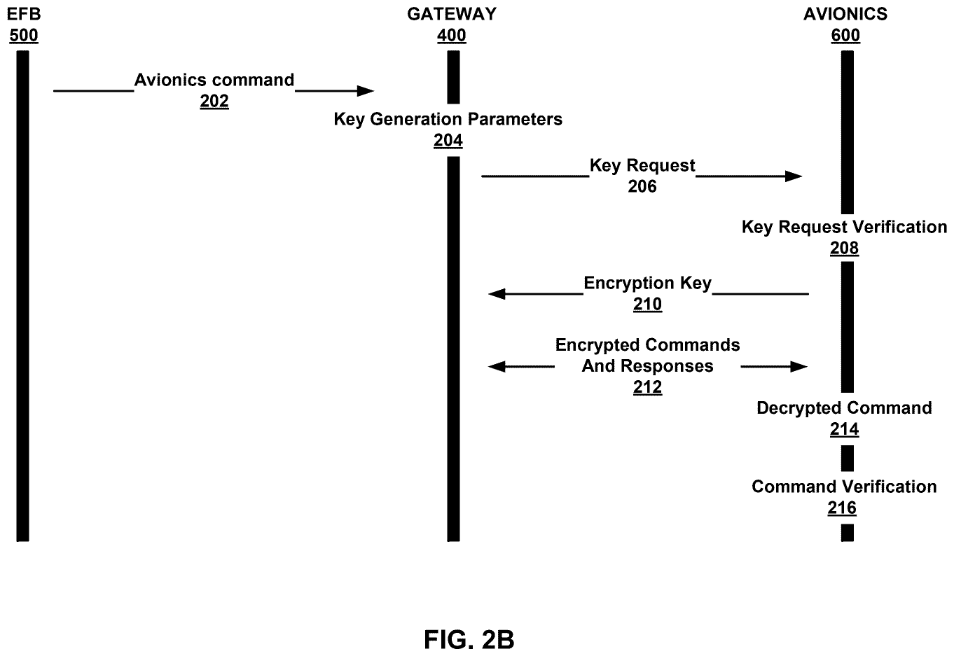

FIG. 2A shows an example of Avionics-EFB connectivity via a gateway device 400 in accordance with techniques of this disclosure. In the example of FIG. 2A, gateway device 400 manages data communication between EFB 500 and avionics 600 to improve the security of the communication. In the example of FIG. 2A, gateway device 400 is configured to ensure that EFB 500 and avionics 600 do not directly communicate but still have seamless communication.

In the example of FIG. 2A, gateway device 400 executes encryption application 422 for facilitating communication between EFB applications 522 of EFB 500 and avionics applications 622, including FMS 602, of avionics 600. In the example of FIG. 2A, gateway device 400 exchanges commands and responses 202 (also referred to below as “command 202”) with EFB 500 using an open-world communication protocols such as WiFi, Bluetooth, or a USB connection. Commands and responses 202 may, for example, include a command, from EFB 500 to avionics 600, to upload, replace, or otherwise modify a flight plan being managed by FMS 602. Commands and responses 202 may also include, for example, a request from EFB 500 to avionics 600 for data and a response from avionics 600 to EFB 500 that includes the requested data.

In response to receiving command 202, key handler 424 of encryption application 422 extracts key parameters from command 202 and generates key request 206. The key parameters may, for example, be a subset of parameters included in command 202.

In response to receiving key request 206, avionics 600 generates encryption key 210 and transmits encryption key 210 to gateway device 400, so that data handler 426 of encryption application 422 can use encryption key 210 to exchange encrypted commands and responses 212 (also referred to below as encrypted command 212) with avionics 600. Data handler 426 may generally be configured to encrypt and decrypt data using encryption key 210.

Using the encryption techniques described herein, gateway device 400 and avionics 600 may engage in bi-directional encrypted communication. That is, gateway device 400 may transmit encrypted commands to avionics 600, and gateway device may also receive encrypted responses from avionics 600. In some instances, gateway device 400 may decrypt responses received from avionics 600 before transmitting those responses to EFB 500. Although not described in detail in this disclosure, gateway device 400 and EFB 500 may secure the transmission and reception of commands and responses 202 using separate encryption or other security protocols.

FIG. 2B is a flow diagram illustrating the data exchange between EFB 500 and avionics 600 via gateway device 400 in FIG. 2A. In the example of FIG. 2B, EFB 500 sends to gateway device 400 avionics command 202, which may for example include a service request or other type of command. In some examples, avionics command 202 may be a command to upload a new flight plan or to update or modify an existing flight plan. In other examples, avionics command 202 may be a request to avionics 600 to retrieve data, such as performance data related to takeoff and landing weights, fuel load, required thrust setting, or other such performance data.

Gateway device 400 extracts key generation parameters 204 from avionics command 202 and sends key request 206, which includes key generation parameters 204, to avionics 600. The key generation parameters may be parameters extracted from avionics command 202. For example, a flight plan to be uploaded to FMS 602 of avionics 600 may include a departure location, an arrival location, a fuel load value, a cruise level, a distance to destination, a time of departure, a time of arrival, a waypoint, such as a point of leaving of a country. Any combination or permutation of this information or other information may be included with key request 206 as key generation parameters 204.

Gateway device 400 may, for example, extract key generation parameters randomly or pseudo randomly, or may extract key generation parameters based on a defined extraction scheme. For example, for avionics commands associated with uploading new flight plans, gateway device 400 may be configured to extract a fixed subset of information, such as departure location and arrival location, while for other types of avionics commands, such as updates to existing flight plans, gateway device 400 may be configured to extract a different fixed subset of information, such as a single waypoint if the update includes changes to the waypoints or an altitude value if the updated includes changes to an altitude value. Gateway device 400 may also be configured to extract numbers without context from avionics command 202 and include those numbers in the key generation parameters.

Avionics 600 performs key request verification process 208 on key request 206. Key request verification process 208 may be either pilot driven or automated. In this context, automated means that the key request verification process may be performed by avionics 600 without user input, e.g., pilot feedback or pilot input. If pilot driven, avionics 600 may, for example, present to a pilot an indication that EFB 500 is attempting to transmit data to avionics 600. The pilot may receive a preview of the data, e.g., from the key generation parameters or other information such as a summary block of the command. The pilot may then provide user input indicating either that the key request from EFB 500 is approved or that the key request is denied.

If automated, avionics 600 may approve or deny the transmission based on a defined set of criteria, such as suitability to a mission being performed by FMS 602. As one example, avionics 600 may determine if a change in cruise altitude is appropriate for a current aircraft state and compatible with other parameters in the request before generating the key. In some examples, avionics 600 may determine that a change in cruise altitude is incompatible while flying a descent and thus not generate a key for gateway device 400 to upload the data. In some examples, avionics 600 may determine that key request 206 includes a command to change an amount of fuel onboard and thus, prompt a pilot to review the request manually, rather than automatically approve the request. In some examples, avionics 600 may determine that key request 206 includes a command that is incompatible with a current flight status, such as a takeoff change request after being airborne or the addition of a new waypoint that significantly deviates from an expected flight path for a particular pair of departure and arrival locations, and thus reject the key request.

If key request verification process 208 does not verify the key request, then avionics 600 rejects the key request and does not generate a unique key based on the flight information included with key request 206. If key request verification process 208 verifies the key request, then avionics 600 generates a unique key based on the flight information included with key request 206. Thus, using the key generation parameters, avionics 600 may generate or select different keys for different avionics commands rather than reusing the same key. Avionics 600 transmits encryption key 210 to gateway device 400. Avionics 600 may also store a copy of the key generation parameters that were used to generate the key and associate the stored key generation parameters with encryption key 210.

Gateway device 400 receives encryption key 210 from avionics 600 and encrypts avionics command 202 to generate encrypted command 212. Gateway device 400 transmits encrypted command 212 to avionics 600. Avionics 600 decrypts encrypted command 212, using a decryption key that corresponds to encryption key 210, to generate decrypted command 214. Encrypted command 212 may, for example, be unintelligible ciphertext (encrypted data), and decrypted command 214 may be plain text.

Avionics 600 performs command verification process 216 on decrypted command 214. For example, avionics 600 may be configured to determine whether decrypted command 214 contains the same key generation parameters, e.g., the same flight information, included with key request 206. If decrypted command 214 does not contain the same key generation parameters included with key request 206, then avionics 600 may reject the command or request additional verification, from a pilot for instance, before executing the decrypted command. If decrypted command 214 does contain the same key generation parameters included with key request 206, then avionics 600 may accept and process the command. For example, avionics 600 may upload a new flight plan to FMS 602 or modify an existing flight plan being executed by FMS 602 based on decrypted command 214.

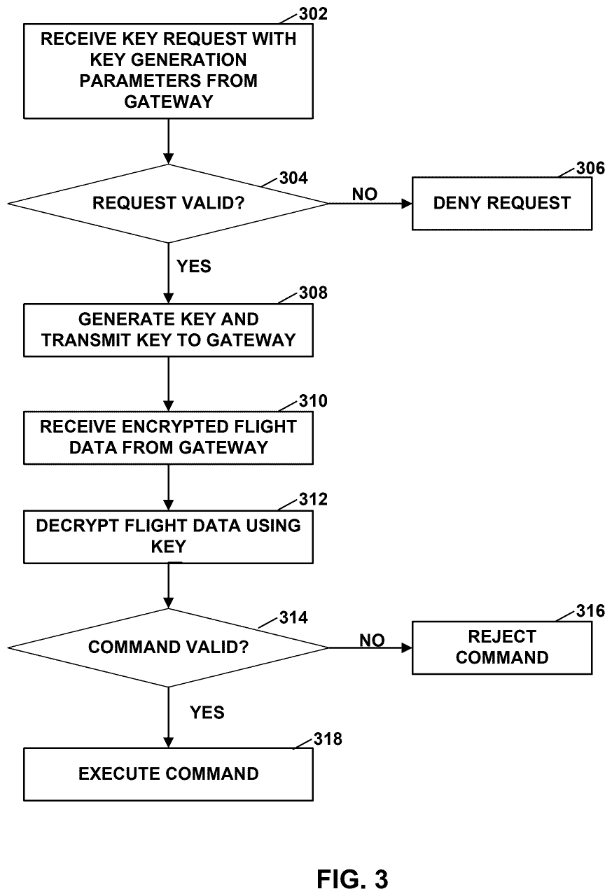

FIG. 3 is a flow diagram illustrating a data transfer process in accordance with the techniques of this disclosure. The example of FIG. 3 will be described from the perspective of avionics 600; however, it is contemplated that other devices may also perform the process of FIG. 3. Avionics 600 receives a key request with key generation parameters from gateway device 400 (302). The key generation parameters may, for example, be a subset of flight information that gateway device 400 received in avionics command from EFB 500.

Avionics 600 determines if the request is valid (304). Avionics 600 may, for example, determine if the request is valid based on determining whether the subset of flight information received in the key generation parameters is compliant with any number of security policies or operational policies or whether the subset of flight information is consistent with a current flight plan or aircraft status.

As one example, avionics 600 may determine whether to accept or reject the key request based on a current status of the aircraft by, for example, determining whether the key generation parameters are within threshold values for the current status of the aircraft. For instance, if the current status of the aircraft is that the aircraft is in descent, then avionics 600 may reject any command that includes changes to speed, altitude, or any other operating parameter by an amount greater than what would be consistent with being in descent. As another example, if the current status of the aircraft is that the aircraft is a significant distance from a final destination, then avionics 600 may reject any command that would include lowering the altitude of the aircraft by more than a threshold amount. As another example, avionics 600 may reject any request that includes key generation parameters associated with impermissible departure locations, destinations, waypoint locations, or altitudes.

If the request is not valid (304, no), then avionics 600 denies the request (306). For example, if the subset of flight information includes a flight duration value that is impractical for a given pair of departure and destination locations, if the fight information includes a departure destination location not accessible in a navigational database, or if the flight information includes a waypoint in restricted airspace, then avionics 600 may deny the request. In this context, denying a request may not necessarily mean dismissing a request, but instead may mean not automatically processing the request. In some examples, a denied request may still be processed if a pilot manually authorizes the request.

If the request is valid (304, yes), then avionics 600 generates and transmits a key to gateway device 400 (308). Avionics 600 may, for example, determine that the request is valid by ensuring that the subset of flight information is both internally consistent and aligns with other flight information known by avionics 600. This involves verifying that the data does not conflict with existing parameters or operational constraints. For instance, if avionics 600 is actively managing an ongoing flight, it may confirm that a new waypoint is directionally consistent with a desired destination and falls within an acceptable range of variance from a typical flight path for that destination or from other waypoints. This may help to ensure that the proposed changes do not introduce unnecessary deviations or risks. Additionally, avionics 600 may check for compliance with regulatory requirements and operational guidelines, ensuring that the request adheres to safety and efficiency standards. If the request is determined to be valid, avionics 600 may store an association of that subset of flight information with the generated key, creating a secure link between the data and the encryption key. This association allows for efficient retrieval and verification of the data during subsequent communications, ensuring that only authorized and validated information is processed.

Avionics 600 then receives encrypted flight data from gateway device 400 (310) and decrypts the encrypted flight data using a decryption key corresponding to the encryption key that was transmitted to gateway device 400 (312). The decrypted flight data may, for example, correspond to a command, such as a service request, and avionics 600 may determine if the command is valid (314). The command may, for example include a full set of flight information. If the command is not valid (314, no), then avionics 600 rejects the command (316). Avionics 600 may, for example, determine whether the command is valid based on the whether or not the full set of flight information includes the subset of flight information used to generate the key. If the full set of flight information does not include the subset of flight information, then this may be indicative that the command is either erroneous or malicious.

If the command is valid (314, yes), then avionics 600 executes the command (318).

After executing the command, avionics 600 may send an encrypted response to gateway device 400. The encrypted response may, for example, include a confirmation that the command was executed, an error message indicating the command was not executed (despite being validated), aircraft status information, flight status information, etc.

Below is a first example flight plan for a flight from New York JFK airport to Los Angeles International Airport (LAX) using a .RTE file formatting.

### [FLIGHT]

ID: NYK123
DEP: JFK
ARR: LAX
DATE: 2024 Oct. 3
TIME: 10:00

### [ROUTE]

WPT1: JFK
WPT2: N32.0701 W110.5629
WPT3: N32.4911 W97.2145
WPT4: N36.0728 W86.4041
WPT5: LAX

### [ALTITUDE]

FL: 350

### [ALTERNATES]

ALTN1: SAN
ALTN2: SFO

### [NOTES]

Departure via SID: JFKSID1
Arrival via STAR: LAXSTAR1

In the example above, the flight information, listed under [FLIGHT] includes a flight identification (ID), a departure airport (JFK), an arrival airport (LAX), a date, and time of departure. The information included under [ROUTE] lists the waypoints in the flight plan.

The information included under [ALTITUDE] indicates the cruising altitude, set at Flight Level 350 (35,000 feet) in the example above. The information listed under [ALTERNATES] specifies alternate airports in case of diversion. The information under [NOTES] lists additional instructions regarding Standard Instrument Departures (SID) and Standard Terminal Arrival Routes (STAR). It should be understood that various fields shown above are merely intended to be examples and are not an exhaustive list of all the fields that may be included in a .RTE flight plan.

For purposes of example, assume that the flight plan above is a new flight plan being transmitted from EFB 500 to avionics 600. As part of sending a key request to avionics 600, gateway device 400 may extract one or more portions of the avionics command, including one or more portions of the flight plan. The one or more portions may be any numbers or text included in the flight plan and may or may not include context. As an example, gateway device 400 may extract the portion ARR: LAX which includes the context that LAX refers to the arrival airport. Additionally, or alternatively, gateway device 400 may extract a number such as 5629 without any context. For example, the number 5629 appears in WPT2, but without the full context of “WPT2: N32.0701 W110.5629,” the number 5629 does not have any decipherable meaning to an external device. Gateway device 400 may then transmit a key request that includes the key generation parameters ARR: LAX and 5629 to avionics 600. Upon receiving the key request with these parameters, avionics 600 may, for example, confirm that ARR: LAX is a location included in a navigational database of avionics 600.

If the value associated with ARR is included in the navigational database, then avionics 600 generates an encryption key based on the key generation parameters ARR: LAX and 5629. Using key generation parameters in this way introduces entropy into the key generation process and allows avionics 600 to generate encryption keys with some amount of randomness or pseudo randomness. For example, avionics 600 may generate a value based on the text and numbers received in the key generation parameters and use that value as a seed value for a cryptographic algorithm that generates encryption keys. By using key generation parameters such as the arrival airport (LAX) and a numerical value (5629), avionics 600 may generate unique keys or at least minimize the amount of times keys are reused.

Avionics 600 may then transmit the encryption key to EFB 500 and receive, from EFB 500 in return, an encrypted version of an avionics command. After avionics 600 decrypts the encrypted version of the avionics command, using a decryption key corresponding to the encryption key, avionics 600 may confirm that the fully decrypted command includes the key generation parameters. For example, upon receiving a command to upload the flight plan above, avionics 600 may confirm that the arrival airport for the flight plan is LAX and confirm that the flight plan includes the number 5629 somewhere. In this particular instance, avionics 600 would determine that WPT2 includes the number 5629, and thus the command can be validated and executed.

As another examples, gateway device 400 may receive from EFB 300 a command to change a flight path by changing the waypoints associated with the flight path. Gateway device 400 may, for example, extract a single waypoint to include in the key request. Gateway device 400 may then transmit, to avionics 600, a key request that includes that single waypoint as a key generation parameter.

Upon receiving the key request with the key generation parameter of the waypoint, avionics 600 may confirm via a navigational database that the new waypoint is not in restricted airspace. Additionally, avionics 600 may confirm that the waypoint is within a range of waypoints acceptable for a JFK to LAX flight path by, for example, determining if a latitudinal value for the waypoint is above a northern most latitudinal value allowed for JFK to LAX or if the latitudinal value for the waypoint is below a southern most latitudinal value allowed for JFK to LAX. If the aircraft is midflight between JFK and LAX, then avionics 600 may confirm that the new waypoint corresponds to a reasonable path with respect the aircraft's current location, the locations of the other waypoints, and the arrival location. If the new waypoint passes these checks, then avionics 600 may proceed with key generation and transmit a copy of the key to gateway device 400.

Below is a second example flight plan for a flight from New York JFK airport to Los Angeles International Airport (LAX) using a .FPL file formatting.

### SUMMARY

FPL: NYK123
TYPE: A320
DEP: JFK
ARR: LAX
DATE: 2024 Oct. 3
ETD: 10:00
ETA: 13:30
ALT: 350
HASH: 5d41402abc4b2a76b9719d94811017c592

### [ROUTE]

JFK CYNTH RIC JONZO BEALE SAC LAX
[WAYPOINTS]
CYNTH: N40.6392 W73.7787
RIC: N36.8500 W76.2920
JONZO: N35.9700 W119.7083
BEALE: N34.7913 W119.5391
SAC: N38.5769 W121.4945

### [ALTERNATES]

SAN
SFO

### [NOTES]

Departure via SID: JFKSID1
Arrival via STAR: LAXSTAR1

In the example above, the flight information listed under [SUMMARY] is a summary of the flight plan, including a hash for error checking. In the example above, the FPL field includes a flight plan identifier, and the TYPE field includes an aircraft type (e.g., A320 or 747). The DEP field includes a departure airport (JFK), and the ARR field includes an arrival airport (LAX). The DATE field includes the flight date. The ETD field includes an estimated time of departure, and the ETA field includes an estimated time of arrival. The ALT field includes a cruising altitude (FL350 for 35,000 feet).

The ROUTE field lists the waypoints or fixes in the flight path, and the WAYPOINTS field lists the latitude and longitude for each waypoint. The ALTERNATES field specifies alternate airports in case of diversion, and the NOTES field includes additional instructions regarding SID and STAR. It should be understood that various fields shown above are merely intended to be examples and are not an exhaustive list of all the fields that may be included in a .FPL flight plan.

A .FPL file typically includes what is referred to as a summary block, which contains key information about the flight in a concise format. A .RTE file often includes a similar summary block. The summary block may serve as a quick reference for pilots and flight planners, summarizing essential details of the flight plan. In the example above, the first set of fields, i.e., FPL, DEP, ARR, DATE, ETD, ETA, and ALT may form a summary block. In other examples, a summary block may include more, fewer, or different fields.

For purposes of example, assume that the second example flight plan above is a new flight plan being transmitted from EFB 500 to avionics 600. As part of sending a key request to avionics 600, gateway device 400 may extract a summary block from the flight plan. As an example, gateway device 400 may extract the portion of the second flight plan that includes the first set of fields, i.e., FPL, DEP, ARR, DATE, ETD, ETA, and ALT and transmit a key request that includes these fields and values as key generation parameters.

Upon receiving the key request with these parameters, avionics 600 may confirm that ARR: LAX and JFK are locations included in a navigational database of avionics 600 and confirm that A320 matches the aircraft type on which avionics 600 is installed. Avionics 600 may also, for example, confirm that the value included in the DATE field is a present or future date and not a past date. Avionics 600 may, for example, confirm that the value included in the DATE field is not a past date and is not too far in the future. Avionics 600 may alternatively or additionally confirm that the ETD and ETA represent an appropriate amount of flight time for flying from JFK to LAX and confirm that the value in the ALT field is not above or below a maximum or minimum value.

If the information included in the summary block fails any of these checks, then avionics 600 may deny the key request. Denying the key request may, for example, include prompting a pilot or other use to confirm the accuracy of data included in the key request or sending an error message to EFB 500, via gateway device 400, indicating that the key request, and hence the original command, was denied.

If the information included in the summary block passes all of these checks, then avionics 600 generates an encryption key based on any of the key generation parameters included in the summary block. Avionics 600 may generate a value based on the text and numbers received in the key generation parameters and use that value as a seed value for a cryptographic algorithm that generates encryption keys. Avionics 600 may use any algorithm or technique and any inputs to generate the seed value as long as the algorithms and inputs produces random or pseudo random values, thus resulting in some randomness or pseudo randomness in the encryption keys used.

Avionics 600 may then transmit the encryption key to EFB 500 and receive, from EFB 500 in return, an encrypted version of an avionics command. After avionics 600 decrypts the encrypted version of the avionics command, using a decryption key corresponding to the encryption key, avionics 600 may confirm that the fully decrypted command includes the same summary block that was included with the key generation parameters. If the fully decrypted command does not include the same summary block, then avionics 600 may deny the command by, for example, not automatically executing the command but instead prompting a pilot to review the command and associated flight information.

The details of this disclosure have been described using several examples with respect to specific key parameters being extracted in a specific manner. It should be understood, however, that the various extraction techniques described herein may be applied to any parameter or combination of parameters in a flight plan.

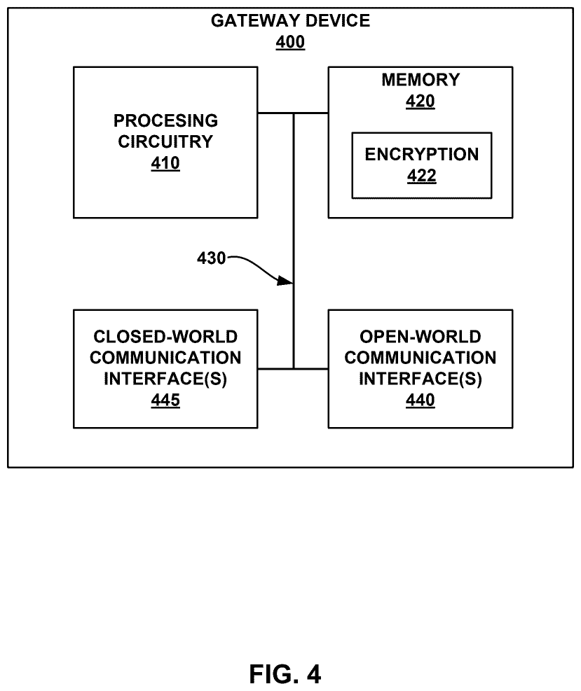

FIG. 4 illustrates an example of gateway device 400. Although this disclosure presents gateway device 400 as being separate from avionics 600, in many implementations gateway device 400 may be a component of avionics 600 or otherwise highly integrated with avionics 600. Gateway device 400 may, for example, be a subsystem of avionics 600 that is configured to transmit and receive data from open-world sources over internet-based or other open-world communications protocols, whereas other subsystems of avionics 600 are restricted from, or otherwise not capable of, communicating with open-world sources. In this regard, gateway device 400 generally represents a boundary between proprietary functions of the avionics and computing systems external to avionics 600.

Gateway device 400 generally performs the encryption techniques described herein. In the example of FIG. 4, gateway device 400 includes processing circuitry 410, memory 420 which stores encryption application 422, open-world communication interface(s) 440, closed-world communication interface(s) 445. The aforementioned components of gateway device 400 may be connected to one another through a bus 430, which generally represents one or more busses and is intended to generically represent all the electrical and data connectivity of internal components included within gateway device 400.

Processing circuitry 410 implements the functionality of and/or executes the instructions associated with encryption application 422. Encryption application 422 may, for example, implement a symmetric encryptions scheme, such as the Advanced Encryption Standard, the Data Encryption Standard, the International Data Encryption Algorithm, or a Rivest Cipher scheme. Alternatively, encryption application 422 may implement an asymmetric encryption scheme, such as Rivest-Shamir-Adleman encryption, Diffie-Hellman, Elliptic Curve Cryptography, or Digital Signature Algorithm. Generally speaking, the techniques of this disclosure are agnostic with respect to the specific type of encryption used.

Processing circuitry 410 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, gateway device 400 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within gateway device 400. In some implementations, memory 420 may include a plurality of separate devices and memory units. Theses memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). The aforementioned encryption application (shown in FIG. 4 as encryption 422) may be stored in any volatile and/or non-volatile memory component of memory 420.

Gateway device 400 also includes open-world communication interface(s) 440 for communicating with EFB 500 and closed-world communication interface(s) 445 for communicating with avionics 600. In this context, open-world communication interface(s) 440 generally represents any hardware for communicating via open-world protocols. Open-world protocols are generally considered to be protocols that are publicly available and usually standardized. Examples of open-world protocols include a transmission control protocol/internet protocol (TCP/IP), a hypertext transfer protocol/secure (HTTP/HTTPS), a file transfer protocol (FTP), a secure FTP, a web socket, a constrained application protocol (CoAP), Bluetooth, ZigBee, a network file system (NFS), or the like.

Closed-world communication interface(s) 445 generally represents any hardware for communicating via closed-world protocols. In this context, a closed-world protocol generally refers to a protocol that is proprietary or vendor specific and for which the specifications are not publicly disclosed. A closed-world protocol is typically intended to limit access to specific vendors or products rather than to grant public access. Closed-world communication interface(s) 445 may, for example, include a secured bus for communicating directly with avionics 600.

According to techniques of this disclosure, gateway device 400 may be configured to receive an avionics command from EFB 500. Gateway device 400 may then extract key generation parameters from the avionics command and transmit the key generation parameters to avionics 600. Gateway device 400 may then receive a key from avionics 600 and encrypt the command using the received key.

Gateway device 400 may, for example, facilitate secure data communication between EFB 500 and avionics 600. Processing circuitry 410 may receive, via open-world communication interface(s) 440, an avionics command from EFB 500 that includes flight information. Memory 420 may store instructions that when executed by processing circuitry 410, cause processing circuitry 410 to extract key generation parameters from the flight information. Processing circuitry 410 may then, via closed-world communication interface(s) 445, transmit a key request, including the key generation parameters, to avionics 600. Processing circuitry 410 may then, via closed-world communication interface(s) 445, receive an encryption key generated by avionics 600 based on the key generation parameters. Processing circuitry 410, executing encryption application 422, may encrypt the avionics command using the received encryption key and transmit, via closed-world communication interface(s) 445, the encrypted command to the avionics system. Processing circuitry 410 may also receive, via closed-world communication interface(s) 445, encrypted responses from avionics 600. The encrypted responses may, for example, be acknowledgement messages or messages containing flight status data, aircraft status data, or other such data.

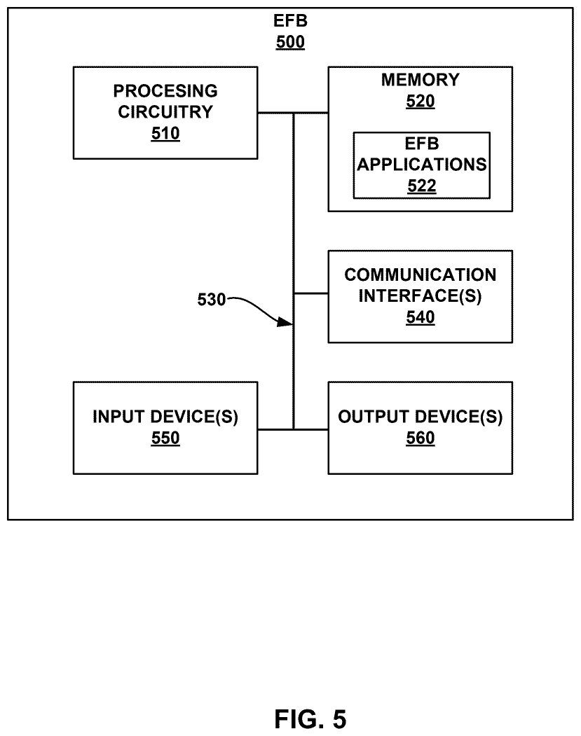

FIG. 5 illustrates an example of EFB 500. EFB 500 may be any sort of generic computing hardware, such as a tablet computer, phone, laptop computer, desktop computer, or other such computing device, that is configured to store and execute EFB applications. EFB 500 may, for example, be a commercially available iOS® device or Android® device executing specialized electronic flight bag software. In other examples, EFB 500 may be specialized computing hardware configured to store and execute EFB applications. Some EFBs may be portable and be able to be carried from plane to plane, while other EFBs may be permanently mounted in a specific airplane. In the example of FIG. 5, EFB 500 includes processing circuitry 510, memory 520 which stores EFB applications 522, and communication interface(s) 540 to communicate with other devices, such as gateway device 400.

Processing circuitry 510 implements the functionality of and/or executes the instructions associated with EFB applications 522. Processing circuitry 510 may be implemented as any of a variety of suitable circuitry that includes a processing system, such as one or more integrated circuits, microprocessors, DSPs, ASICs, FPGAs, discrete logic, software, hardware, firmware or any combinations thereof. When the techniques are implemented partially in software, EFB 500 may store instructions for the software in a suitable, non-transitory computer-readable medium (e.g., memory 520) and execute the instructions in hardware using processing circuitry 510 to perform the techniques of this disclosure.

Memory 520 is intended to generically represent all memory included within EFB 500. In some implementations, memory 520 may include a plurality of separate devices and memory units. Theses memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 5 as EFB applications 522) may be stored in any volatile and/or non-volatile memory component of memory 520.

EFB 500 also includes input device(s) 550 (e.g., a keyboard, mouse, or touchscreen) and output device(s) 560 (e.g., a display, printer). In implementations where EFB 500 is a phone or tablet computer, then the EFB may, for example, have a touchscreen and a display. In implementations where EFB 500 is a larger computer device, then EFB 500 may, for example, have a mouse, trackpad, keyboard, or other such input devices. The aforementioned components of EFB 500 may be connected to one another through a bus 530, which generally represents one or more busses and is intended to generically represent all the electrical and data connectivity of internal components included within EFB 500.

Communication interface(s) 540 generally represents all hardware, e.g., transceiver circuitry, within EFB 500 for communicating with external devices. Communication interface(s) 540 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 540 may include short wave radios, cellular data radios, wireless network radios, as well as universal serial bus (USB) controllers.

EFB applications 522 represent a suite of software tools that may be used by a pilot in managing flight operations. EFB applications 522 may include flight planning applications that allow pilots to create and file flight plans, access weather information, and calculate fuel requirements. EFB applications 522 may also include navigation applications that provide real-time navigation support with maps, airspace information, and waypoint management. EFB applications 522 may also include weather applications that provide real-time weather data, future weather predictions, radar imagery, and the like. EFB applications 522 may also include checklist applications for ensuring compliance with pre-flight, mid-flight, and post-flight procedures. EFB applications 522 may also include various performance analysis tools that, for example, help pilots compute takeoff and landing distances based on current conditions and aircraft configuration. EFB applications 522 may also include aircraft maintenance tracking tools that track aircraft maintenance schedules, inspection records, and compliance records. EFB applications 522 may may also include flight logbooks that enable pilots to log flights, track hours, and generate reports for currency and certification. EFB applications 522 may also include airport information applications that provide information about airports, including runway layouts, services, and notices.

Examples of applications that may be included in EFB applications 522 are Honeywell GoDirect Flight Services®, Honeywell GoDirect Cockpit®, Honeywell Flight Bag®, Honeywell JetWave®, and Honeywell SmartView®.

The various example applications listed above represent a non-exhaustive list of the types of applications that may be included in EFB applications 522. As explained above, some applications of EFB applications 522 may facilitate communication with avionics 600 using the data communication techniques of this disclosure.

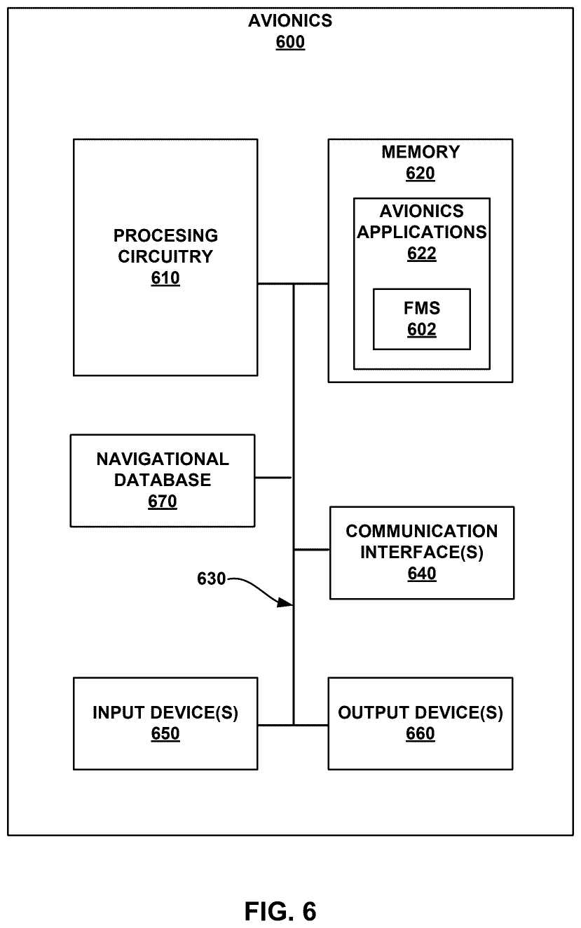

FIG. 6 illustrates an example of avionic 600. Avionics 600 is specialized computing hardware configured to store and execute avionics applications. In the example of FIG. 6, avionics 600 includes processing circuitry 610, memory 620 which stores avionics applications 622, communication interface(s) 640 to communicate with other devices, such as gateway device 400, input device(s) 650, output device(s) 660, and navigational database 670. The aforementioned components of avionics 600 may be connected to one another through a bus 630, which generally represents one or more busses and is intended to generically represent all the electrical and data connectivity of internal components included within avionics 600.

Processing circuitry 610 implements the functionality of and/or executes the instructions associated with avionics applications 622. Processing circuitry 610 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics 600 may store instructions for the software in a suitable, non-transitory computer-readable medium (e.g., memory 620) and execute the instructions in hardware using processing circuitry 610 to perform the techniques of this disclosure.

Memory 620 is intended to generically represent all memory included within avionics 600. In some implementations, memory 620 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 6 as avionics applications 622) may be stored in any volatile and/or non-volatile memory component of memory 620.

Communication interface(s) 640 generally represents all hardware e.g., transceiver circuitry, within avionics 600 for communicating with external devices either on the ground or while in flight. Communication interface(s) 640 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 640 may include short wave radios, cellular data radios, wireless network radios, as well as universal serial bus (USB) controllers. Examples of communication interface(s) 640 for in-flight communication include a very high frequency (VHF) radio, a high frequency (HF) radio, or a satellite communication (SATCOM) radio. Examples of communication interface(s) 640 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 640 used for data links include controller-pilot data link communications (CPDLC) which allows air traffic control to send instructions and receive acknowledgments from pilots via text messages. Communications interface(s) 640 may also include an automatic dependent surveillance-broadcast transponder. The various examples of communications interfaces listed above represent a non-exhaustive list of the types of the types of communication interfaces that may be included in communication interface(s) 640.

Avionics 600 also includes input device(s) 650 and output device(s) 660. Examples of input device(s) 650 include control display units (CDUs) with alphanumeric keypads or touchscreens to enter flight plans, waypoints, and other necessary data. Input device(s) 650 may also include an FMS control panel for entering information to the FMS, such as route, altitude, and speed using dedicated buttons, knobs, and touchscreen interfaces. Input device(s) 650 may also include yoke or sidestick controls as well as touchscreen interfaces. Input device(s) 650 may also include rotary knobs for setting values for altitudes, speeds, and other parameters and toggle switches for selecting modes or turning systems on and off.

Examples of output device(s) 660 may include an electronic flight instrument display to provide visual representations of flight data, including altitude, airspeed, heading, and attitude. Output device(s) 660 may also include a Heads-Up Display (HUD) that projects critical flight information onto a transparent screen in the pilot's line of sight or other cockpit displays to show navigation maps, engine parameters, system statuses, and the like. Output device(s) 660 may also include engine instrumentation displays to display data on engine performance, such as temperature, pressure, and revolutions per minute (RPMs). Output device(s) 660 may also include audio panels to relay communication from radios and alerts from systems to the cockpit. Output device(s) 660 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 650 and output device(s) 660. Additionally, input and output functionality of avionics 600 may facilitated by external devices that are separate from input device(s) 650 and output device(s) 660. For example, EFB 500 may be configured to input data to and output data for avionics 600.

Avionics applications 622 represent a suite of software tools that may be used by a pilot in managing flight operations and managing the aircraft while in flight. Avionics applications 622 includes FMS 602 discussed above as well as other applications for communication, navigation, and monitoring within an aircraft. Avionics applications 622, for example, include applications for processing and displaying weather radar data and presenting essential flight information such as altitude, airspeed, attitude, and heading to a pilot. Avionics applications 622 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 622 may also include the software to manage various emergency systems (e.g., an emergency locator transmitter, flight data recorder, and cockpit voice recorder) and cabin management systems (e.g., passenger infotainment systems and environmental control systems).

Navigational database 670 represents a specialized database that stores information needed by FMS 602 for the navigation and operation of an aircraft for purposes such as flight planning, route management, and ensuring safe navigation throughout a flight. Navigational database 670 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 670 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 670 may be regularly updated to reflect changes in air traffic regulations, airport information, and navigational aids to ensure pilots have current information for safe and efficient flight operations.

Although not explicitly shown in FIG. 6, avionics 600 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 600 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Avionics 600 may be configured to securely receive data uploads from EFB 500 via gateway device 400. Processing circuitry 610 may receive, via communication interface(s) 640, a key request from gateway device 400. The key request may include key generation parameters corresponding to a subset of a set of flight information. Processing circuitry 610 may generate an encryption key based on the key generation parameters and transmit, via communication interface(s) the encryption key to gateway device 400. Processing circuitry 610 may then receive, from gateway device 400, an encrypted version of an avionics command. Processing circuitry 610 decrypts the encrypted version of the avionics command, using a decryption key corresponding to the encryption key, to determine a decrypted version of the avionics command. Processing circuitry 610 may determine whether to deny or execute the avionics command by confirming that the subset of flight information received as key generation parameters is present in the full set of flight information received as part of the avionics command. In response to determining that the flight information includes the key generation parameters, processing circuitry 610 may, for example, execute the avionics command by updating a flight plan being managed by FMS 602 or modifying or updating some other aspect of avionics applications 622.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method for controlling data communication by avionics of an aircraft, the method comprising:
receiving a key request from a computing device, wherein the key request includes key generation parameters;
generating an encryption key based on the key generation parameters;
transmitting the encryption key to the computing device;
receiving, from the computing device, an encrypted version of an avionics command;
decrypting the encrypted version of the avionics command, using a decryption key corresponding to the encryption key, to determine a decrypted version of the avionics command, wherein the decrypted version of the avionics command includes flight information; and
in response to determining that the flight information includes the key generation parameters, executing the avionics command.

2. The method of claim 1, further comprising:
determining whether to accept or reject the key request based on a current status of the aircraft; and
transmitting the encryption key to the computing device in response to determining to accept the key request.

3. The method of claim 2, wherein determining whether to accept or reject the key request based on the current status of the aircraft comprises determining whether to accept or reject the key request based on whether the key generation parameters are within threshold values for the current status of the aircraft.

4. The method of claim 1, further comprising:
prompting a pilot to accept or reject the key request; and
transmitting the encryption key to the computing device in response to receiving a user input from the pilot to accept the key request.

5. The computer-implemented method of claim 1, wherein the avionics comprises a flight management system and executing the avionics command comprises modifying a flight plan being executed by the flight management system based on the flight information.

6. The computer-implemented method of claim 1, wherein the avionics comprises a flight management system and executing the avionics command comprises creating a new flight plan to be executed by the flight management system based on the flight information.

7. The computer-implemented method of claim 1, wherein the computing device comprises a subsystem of the avionics.

8. An avionics system mounted on an aircraft, the avionics system comprising:
one or more memories; and
processing circuitry coupled to the one or more memories and configured to:
receive a key request from a computing device, wherein the key request includes key generation parameters;
generate an encryption key based on the key generation parameters;
transmit the encryption key to the computing device;
receive, from the computing device, an encrypted version of an avionics command;
decrypt the encrypted version of the avionics command, using a decryption key corresponding to the encryption key, to determine a decrypted version of the avionics command, wherein the decrypted version of the avionics command includes flight information; and
in response to determining that the flight information includes the key generation parameters, executing the avionics command.

9. The avionics system of claim 8, wherein the processing circuitry is further configured to:
determine whether to accept or reject the key request based on a current status of the aircraft; and
transmit the encryption key to the computing device in response to determining to accept the key request.

10. The avionics system of claim 9, to determine whether to accept or reject the key request based on the current status of the aircraft, the processing circuitry is configured to determine whether to accept or reject the key request based on whether the key generation parameters are within threshold values for the current status of the aircraft.

11. The avionics system of claim 8, wherein the processing circuitry is further configured to:
determine whether to accept or reject the key request based on a current status of the aircraft; and
not transmit the encryption key to the computing device in response to determining to reject the key request.

12. The avionics system of claim 8, wherein the processing circuitry is further configured to:
prompt a pilot to accept or reject the key request; and
transmit the encryption key to the computing device in response to receiving a user input from the pilot to accept the key request.

13. The avionics system of claim 8, wherein the processing circuitry is further configured to:
prompt a pilot to accept or reject the key request; and
not transmit the encryption key to the computing device in response to receiving a user input from the pilot to reject the key request.

14. The avionics system of claim 8, further comprising:
a flight management system,
wherein to execute the avionics command, the processing circuitry is configured to modify a flight plan being executed by the flight management system based on the flight information.

15. The avionics system of claim 8, further comprising:
a flight management system,
wherein to execute the avionics command, the processing circuitry is configured to create a new flight plan to be executed by the flight management system based on the flight information.

16. The avionics system of claim 8, wherein the computing device comprises a subsystem of the avionics system.

17. A computer-implemented method for controlling data communication with an avionics system of an aircraft, the method comprising:
receiving, at a gateway device, an avionics command from an external computing device, wherein the avionics command includes flight information;
extracting from the flight information, by the gateway device, key generation parameters from the avionics command;
transmitting, by the gateway device, a key request to the avionics system, wherein the key request includes the key generation parameters;
receiving, at the gateway device, an encryption key generated based on the key generation parameters from the avionics system; and
transmitting, by the gateway device, an encrypted version of the avionics command to the avionics system.

18. The computer-implemented method of claim 17, wherein the avionics command comprises instructions to one of modify an existing flight plan being executed by a flight management system or a create a new flight plan to be executed by the flight management system.

19. The computer-implemented method of claim 17, wherein the external computing device comprises a tablet device.

20. The computer-implemented method of claim 17, wherein the gateway device comprises a subsystem of the avionics system.
